(19) United States
(12) Patent Application Publication
(10) Pub. No.: US 2026/0217527 A1
(43) Pub. Date: Jul. 30, 2026

(54) TRICONVERSION SYNGAS PROCESS WITH CO2 RECYCLE

(71) Applicant: Aether Fuels Pte. Ltd., Singapore (SG)

(72) Inventors: Malou Camara, Bridgewater, NJ (US); Sanjiv Dabee, Aliso Viejo, CA (US); Scott Tatro, Chicago, IL (US)

(73) Assignee: Aether Fuels Pte. Ltd., Singapore (SG)

(21) Appl. No.: 19/364,420

(22) Filed: Oct. 21, 2025

Related U.S. Application Data
(60) Provisional application No. 63/751,451, filed on Jan. 30, 2025.

(51) Int. Cl. C01B 3/38

(52) U.S. Cl. CPC C01B 3/38; C01B 2203/0233; C01B 2203/0238; C01B 2203/0405; C01B 2203/046; C01B 2203/0475; C01B 2203/1241; C01B 2203/148

(57) ABSTRACT

Methods of making syngas, and making chemical products from syngas, are described herein. A reactor is used to convert methane and carbon dioxide to syngas. Carbon dioxide is separated from an effluent of the reactor and recycled to the reactor.

### CROSS REFERENCE TO RELATED APPLICATIONS

This application for patent claims priority benefit of U.S. Provisional Patent Application Ser. No. 63/751,451 filed Jan. 30, 2025, which is entirely incorporated herein by reference.

### BACKGROUND

Technologies are being developed for making chemical products using renewable and sustainable sources of carbon. Such processes generally convert methane, carbon dioxide, and optionally hydrogen into syngas, a mixture of carbon monoxide and hydrogen, which can be used as a reaction mixture in chemical products manufacturing processes such as Fischer-Tropsch. Methods and apparatus are needed to make efficient and effective use of raw materials for such processes.

### SUMMARY

Embodiments described herein provide methods, comprising converting methane and carbon dioxide to syngas in a Tri-Converter reactor; separating carbon dioxide from an effluent of the Tri-Converter reactor, or a stream derived from the effluent; and recycling at least a portion of the separated carbon dioxide back to the Tri-Converter reactor.

Other embodiments described herein provide methods, comprising obtaining carbon-based feedstock from a facility that uses a Tri-Converter reactor to make syngas and recycles carbon dioxide from an effluent of the Tri-Converter reactor; and forming one or more chemical products from the syngas.

Other embodiments described herein provide methods that include providing a stream comprising methane, carbon dioxide, and water, hydrogen, or both, to a Tri-Converter reactor; converting at least a portion of the methane and carbon dioxide, in the Tri-Converter reactor, to an effluent comprising unconverted carbon dioxide, unconverted methane, carbon monoxide, water, and hydrogen gas; removing water from the effluent of the Tri-Converter reactor to form a dehydrated effluent; separating carbon dioxide from the dehydrated effluent to form a conversion feed and a recycle comprising carbon dioxide; routing the recycle back to the Tri-Converter reactor; and forming one or more chemical products from the conversion feed.

### BRIEF DESCRIPTION OF THE DRAWINGS

FIG. 1 is a process diagram of a sustainable carbon material conversion process according to one embodiment.

FIG. 2 is a process diagram of a sustainable carbon material conversion process according to another embodiment.

### DETAILED DESCRIPTION

Methods and apparatus are described herein for producing syngas using a reactor that converts methane and carbon dioxide to carbon monoxide, with reuse of carbon dioxide effluent from the reactor. A Tri-Converter reactor is a reactor that can stably and directly convert methane and carbon dioxide into syngas (a mixture of carbon monoxide, CO, and hydrogen gas, H₂) via steam reforming, the conversion of CH₄ and steam into CO and H₂, and dry reforming, the conversion of CH₄ and CO₂ into CO and H₂. The reactor is a Tri-Converter reactor because under many conditions a third reaction, the Water Gas Shift Reverse Water Gas Shift will occur where CO₂ and H₂ are converted to CO and H₂O. The syngas produced by a Tri-Converter reactor, from an appropriate feed stream, has an attractive ratio of H₂ to CO, usually between about 1.5 and 2.5 suitable for chemical product manufacture using Fischer-Tropsch methods or other chemicals manufacturing methods. This ratio can be tuned by adjusting the input feed composition (e.g. the stream composition relative to the other components) and by adjusting the temperature and pressure (which shift the thermodynamic equilibrium of the various reactions).

The Tri-Converter reactor comprises one or more vessels. These may be elongated pressure vessels, such as drums or tubes, or any suitable vessel configuration. A vessel of this type contains a catalyst, which may be formed in a catalyst bed, or coated or adhered onto, or embedded within, a structure of the vessel in a way that provides exposure of the catalyst to reactant fluids. The reactor also comprises a heat delivery system that delivers heat into the reactor to heat the reaction space containing the catalyst to drive the Tri-Conversion reactions, which are in general endothermic, and any additional heat needed to ensure the fluids within the reactor are at the desired process temperature.

The catalyst may comprise a single heterogeneous catalyst, e.g. a noble metal on an oxide support, or multiple catalysts, e.g. first catalyst comprising a noble metal on an oxide support and a second catalyst. The catalyst bed has stable activity for steam methane reforming, as CH₄+H₂O [symbol] CO+3H₂, and dry reforming, as CH₄+CO₂ [symbol] 2CO+2H₂.

Conventionally catalysts that have good activity for steam methane reforming do not have good stability for dry reforming, and thus conventionally the feed and process conditions are selected to suppress dry reforming (e.g. by minimizing CO₂ in the feed and/or by utilizing high amounts of steam so that the steam reforming reaction dominates) but methods may form syngas that is suboptimal for downstream chemical product manufacture, having a ratio of H₂ to CO that is typically above 2.5, where the preferred ratio for chemical product manufacture is between 1.5 and 2.5. Such methods can also be suboptimal where it is desired to use CO₂ as part of the input stream and convert it into syngas.

In addition to methane, CO₂, and steam, one can also provide H₂ as an input to the Tri-Converter reactor. As noted above, the Water Gas Shift-Reverse Water Gas Shift reaction, as CO+H₂O [symbol] CO₂+H₂, can occur, and one can introduce H₂ as an input to shift the thermodynamic equilibrium of the reaction. In one embodiment of a process using this kind of reactor, it is even possible to supply only CO₂ and H₂ as input and use the reactor as a reverse water gas shift reactor to convert CO₂ into CO. The reactors used herein are Tri-Converter reactors or other reactors that can directly convert methane and carbon dioxide into syngas.

The heat delivery system of the reactor may utilize conventional combustion-based heating, referred frequently to “firing” so that such a reactor is sometimes called a “fired reactor.” In such cases, a fuel gas is supplied to the heating system and is combusted to produce heat, which is applied to the walls of the pressure vessel and transferred through the walls into the catalyst bed. Alternatively, the heat delivery system of the reactor may utilize electrical-based heating, wherein electric heating elements that convert electrical current and voltage into heat, such as resistive heating elements or inductive heating elements, are configured to generate heat that is then delivered into the catalyst. Radiant and convective heat delivery systems can be used, separately or in combination, and may employ any of the heat sources (electric, combustion, or other sources of thermal energy) described above.

The heat delivery system may have multiple sections, wherein different heat fluxes can be delivered to the reaction space in each section to control the temperature in the reaction space in each section more precisely. As noted above, the reactor can be controlled, and provided with a blend of feedstocks, to yield syngas having a favorable molar ratio of H₂ to CO for chemical product manufacture, which is typically a ratio between 1.5 to 2.5.

Methods described herein reuse carbon dioxide effluent from a Tri-Converter reactor to allow operating the reactor at conditions that provide a broad operating window. The reactions noted above that are performed in such a reactor may have limited conversion of CO₂, and trying to increase single-pass conversion of CO₂ in reforming reactions results in syngas having too much hydrogen relative to the content of carbon monoxide. Additionally, the low conversion of CO₂ in a single-pass process results in unreacted CO₂ that must be handled downstream of the reactor. Finally, in processes that primarily utilize the reverse water gas shift reaction, recycling CO₂ increases overall conversion of CO₂.

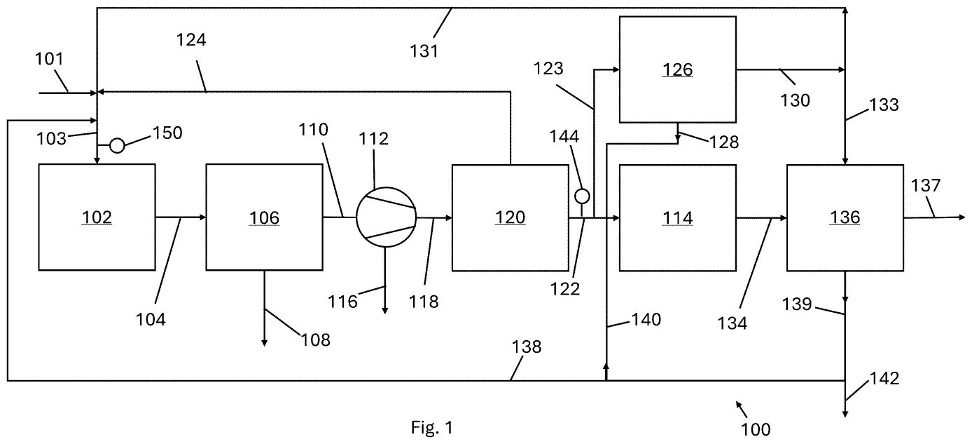

The carbon dioxide content from the effluent of the reactor is thus separated downstream of the reactor and recycled back to the reactor to increase overall conversion of CO₂ at conditions favorable for producing syngas having a suitable composition for conversion to useful chemical products. FIG. 1 is a schematic process flow diagram summarizing a process 100, according to one embodiment. The process 100 uses a Tri-Converter reactor 102 to convert CO₂, and optionally CH₄, into a gas mixture having a molar ratio of H₂ to CO that is between about 1.5 to 2.5, for example about 2.1. An effluent 104 from the reactor 102 comprises H₂, CO, unconverted CO₂, unconverted CH₄, and water. The effluent 104 is routed to a condenser 106 to condense-majority of the water which is removed as a water stream 108. An effluent 110 from the condenser 106 contains H₂, CO, CH4, and CO₂, and some residual water vapor. The condenser effluent 110 may be compressed in a compressor 112 to prepare the condenser effluent 110 for processing in conversion process 114 to make hydrocarbon products The conversion process 114 may be an FT process or other conversion process such as a methanol or alcohol-to-fuel process. The compression may produce a second water stream 116, and yields a gas effluent 118 with only trace amounts of water remaining. Alternatively, the reactor 102 may be operated at a pressure sufficient to support operation of the conversion process downstream with no intermediate compression. Any suitable number of compression and condensation stages can be used, in any suitable arrangement depending on effluent composition and condition.

At this stage, the gas effluent 118 can have a considerable amount of unreacted CO₂. In some cases the gas effluent 118 may be 10% or more CO₂. In a typical version of the process 100, the gas effluent has a mole fraction of CO₂ between about 0.0 and 0.3. Routing the effluent gas, in this state, to the conversion process 114 results in handling potentially large amounts of unreacted CO₂ to the downstream processes. Some downstream processes do not use CO₂, so the CO₂ is just inert gas that must be handled, leading to sizing downstream equipment with larger capacity than is strictly necessary.

Thus, in the process 100, the effluent gas 118 is routed to a CO₂ separator 120 that separates CO₂ from the effluent gas 118 to form a conversion feed 122 and a CO₂ recycle 124. CO₂ in the effluent gas is separated from H₂ and CO so the conversion feed 122 is reduced in CO₂ content. In some cases, the CO₂ separator is operated such that the conversion feed 122 has no CO₂, so that the conversion feed is CO₂-free. In other cases, the CO₂ separator may be operated to provide a conversion feed 122 having a target amount of CO₂, such as a mole fraction of CO₂ that is from 0.0 to 0.3, for example between about 0.05 and 0.3. The process 200, described in more detail below, can flexibly withdraw gas from the effluent 118 or from effluent of the conversion process 114, or both.

The conversion feed 122 of the process 100 is routed to the conversion process 114 for conversion to chemical products. Some FT processes, which can be used as conversion processes in this case, can benefit from a small fraction of CO₂, for example to manage thermal fluxes in the process. As noted above, the CO₂ is essentially inert in the conversion process and can be recycled to the reactor 102. In the process 100, most CO₂ effluent from the reactor 102 is recycled, with trace amounts being lost to gas products and byproducts of the conversion process 114. Recycled CO₂ is added to a fresh feed 101 to the reactor 102, and is eventually converted to hydrocarbon products at an overall conversion of 95-99% in most cases. The fresh feed generally includes methane, and optionally carbon dioxide, and may include other gases such as hydrogen, water vapor, and other light hydrocarbons such as ethane, propane, and butane. Trace inert gases, such as nitrogen and argon, may also be present in the fresh feed 101.

In the CO₂ separator 120, the volume of CO₂ separated can be up to 30% of the volume of the effluent gas 118 that forms the feed to the CO₂ separator 120. Thus, in a circulation loop defined by the Tri-Converter reactor 102, the condenser 106, the compressor 112, and the CO₂ separator 120, the volume of material circulating may be up to one third the volume of material routed from the CO₂ separator 120 to the conversion process 114. The equipment of the conversion process 114 can thus be smaller, and energy consumption of the conversion process 114, for example in heating and compressing, can be much lower than if the CO₂ separator 120 is not used.

The CO₂ separator can use any suitable method, or methods, to separate CO₂ from the conversion feed 122. Because no separation is perfect, the CO₂ recycle 124 usually contains some amount of CH₄, H_{2,} and CO, and potentially H₂O, although the amounts may be trace amounts. For example, if essentially all CO₂, for example 90%, is separated from the effluent gas 118, the CO₂ recycle may contain a molar percentage of CH₄, H_{2,} CO, and H₂O if any, combined that is from 0.5% to 30%. In one embodiment, 90% of CO₂ in the effluent gas 118 is recovered at a purity of 99.5%. However, if the CO₂ separator 120 is operated to provide essentially pure CO₂ as a recycle, the conversion feed 122 may have a molar percentage of CO₂ that is up to 30%. CO₂ separation can be performed using membrane processes, extraction process, cryogenic distillation processes, or a combination thereof. Extraction processes such as amine solvent extraction and propylene carbonate solvent extraction can be used to separate CO₂. Combinations of the above processes can also be used. CO₂ separation can be performed in stages where a first stage performs a first CO₂ separation to form an intermediate that is routed to a second stage that performs a second CO₂ separation.

The CO₂ separator 120 can be controlled to provide a certain amount, or ratio, of CO₂ separation and/or recycle to the reactor 102. Alternatively, the CO₂ separator can be controlled to provide a certain amount, or ratio, of a byproduct. For example, the CO₂ separator can be controlled to provide a certain amount, or ratio, of CH₄ or H₂, or both, for recycle to the reactor 102. Depending on the process or processes used to separate CO₂ from the effluent gas 118, the recycled CO₂ may contain H₂, CH₄, and potentially CO and H₂O in some quantities. The composition of the recycle stream can be adjusted by adjusting operating parameters of the CO₂ separator, such as temperature and pressure. The composition of the gas mixture provided to the reactor 102 for conversion to syngas can be controlled by varying amounts of CO₂, CH₄, and H₂O (steam), and the amount and composition of recycled gas, to achieve a desired composition. As the reactions performed by the reactor are equilibrium reactions that can have CO₂ and H₂ on the “left” and “right” side of the reaction, composition of the stream recycled from the CO₂ separator can affect the reactions taking place in the reactor 102. A controller can monitor conditions of the reactor 102, and composition of the stream recycled from the CO₂ separator, for example using known types of gas analyzers, and can adjust make-up gas rates and reaction conditions to optimize yield of useful syngas.

It should be noted that the process 100 can be operated to consume all CO₂ generated by the reactor 102. Because CO₂ is consumed by some of the reactions in the reactor 102, the CO₂ can be recycled, from the CO₂ separator 120 or from the conversion process 114 downstream, to extinction. The process 100 can be operated to form syngas without needing to release CO₂ to the atmosphere or sequester CO₂ in a sequestration facility. The process 100 can be operated to convert 100% of CO₂ provided in feed to the reactor. Alternatively, a target amount of CO₂ can be released to the downstream conversion to facilitate processes of the downstream conversion. This CO₂ can be recycled from the downstream conversion to the reactor 102, potentially along with other gases such as H₂ and CH₄. Some CO₂ released to the downstream conversion can be purged in various gas purge streams. In general, the process 100 can be operated to convert CO₂ at arbitrary levels up to 100%.

The gases provided to the process 100 can be obtained from renewable sources, such that the process 100 can have negative net greenhouse gas footprint, which is to say the process 100 can make syngas while consuming greenhouse gases. For example, the chemical products made by the process 100 can be made by consuming more greenhouse gases that are emitted by the process 100 or by any combustion of the chemical products. Gases for use in the process 100 can be obtained from fossil fuel sources such as petroleum or from renewable sources such as biomass and biogeneration and can be used as feedstocks for a Tri-Converter reactor. Here, CO₂ can be recycled to the reactor to extinction so there is no CO₂ in the final product or byproduct that needs handling. Methane can be obtained from a renewable methane source such as a biomethane source, an organic gasification source, a Sabatier facility, or other such sources.

Optionally, H₂ in the conversion feed 122 can be adjusted to achieve optimal operation of the conversion process 114. An optional hydrogen separator 126 can receive all or a portion of the conversion feed 122 and can be operated to remove a portion of the H₂ from the conversion feed 122 to yield a hydrogen-adjusted conversion feed 128 along with a H₂-rich stream 130. Thus, for example, a hydrogen separator feed 123 can be separated from the conversion feed 122 and routed to the hydrogen separator 126. The hydrogen separator 126 can be, or can include, any known apparatus, or combination of apparatuses, for separating hydrogen from a gas stream, such as a membrane separation unit, a pressure-swing absorption unit, or combination thereof. The conversion process 114 produces an effluent 134 that can be routed to a finishing unit 136 for final processing. The finishing unit 136 produces a product 137.

Where the conversion process 114 is an FT process, the finishing unit 136 can be configured to crack, hydrogenate, isomerize, separate, purify, and generally prepare hydrocarbon products for sale as the product 137. Where the conversion process 114 is a methanol process, or other chemical conversion process, the finishing unit 136 can generally purify and or prepare the product 137 for sale. The H₂-rich stream 130, or a portion thereof, can be routed to the finishing unit 136 in a forwarded H₂-rich stream 133 for use in the cracking and hydrogenation operations. Alternatively, the H₂-rich stream 130, or a portion thereof, can be routed to the Tri-Converter reactor 102 in a recycled H₂-rich stream 131. The finishing process produces one or more byproduct streams, any of which can be routed to the reactor 102, if the composition of such stream is suitable. For example, where CO₂ is forwarded to the conversion process 114 from the CO₂ separator 120, the CO₂ may exit in a byproduct stream 139, at least a portion of which can be recycled to the reactor 102 in a byproduct recycle stream 138. Recycling some or all of the byproduct stream 139 routes CO₂ passed through the conversion process 114 back to the reactor 102 to supplement CO₂ in the fresh feed 101 or in other recycle streams. Where conversion in the conversion process 114 is low, a return portion 140 of the byproduct stream 139 can be routed back to the conversion process 114 to balance use of reactants between the reactor 102 and the conversion process 114. The recycle streams 124, 131, and 138, if any, are all combined with the fresh feed 101 to form a feed stream 103 that is provided to the reactor 102. The feed stream 103 can be thermally conditioned prior to entry to the reactor 102, for example by thermal exchange (not shown) with the reactor effluent 104, and/or by thermal exchange with a heating medium in a heater or heat exchanger.

A purge stream 142 can be separated from the byproduct stream 139 to manage quantity of inert gases circulating in the process 100. For example, where raw materials, such as natural gas, may contain nitrogen, argon, or other inert gas, and those gases are not output in the product 137, such gases can build up as gases are recycled in the process 100. The purge stream 142 can be controlled based on a composition of one or more gases in the process 100. For example, a sensor unit 144 can be coupled to the conversion feed 122 to provide signals representing a condition of the conversion feed 122. The sensor unit 144 can be, or can include, a gas analyzer, temperature, and/or pressure sensors. Such sensors can also be provided and separately coupled to the conversion feed 122, or to other streams of the process 100.

A gas analyzer coupled to the conversion feed 122, such as in the sensor unit 144, can provide signals representing composition of the conversion feed, for example concentration of hydrogen, carbon monoxide, carbon dioxide, and/or inert gases such as nitrogen and argon. The process 100 can be controlled using such signals. For example, a flow rate of the hydrogen separator feed 123 can be controlled based on concentration of hydrogen or based on molar ratio of hydrogen to carbon monoxide in the conversion feed 122 to target quantities of hydrogen and carbon monoxide in the feed to the conversion process 114. Thus, where a ratio of hydrogen to carbon monoxide in the conversion feed is above a target or a target range, a signal from the sensor unit 144 can be used to determine an increase in flow rate of the hydrogen separator feed 123, and processing rate of the hydrogen separator 126, to remove hydrogen and return the hydrogen-adjusted conversion feed, having a reduced amount of hydrogen, to the conversion process 114.

Signals from a gas analyzer that represent quantity of carbon dioxide in the conversion feed 122 can also be used to control the CO₂ separator 120. Where a quantity of carbon dioxide in the conversion feed 122 is above a target or target range, as determined using signals from a gas analyzer, operation of the CO₂ separator 120 can be adjusted to remove more CO₂ from the conversion feed 122 to recycle to the reactor 102. Where the quantity of carbon dioxide in the conversion feed 122 is below the target or target range, operation of the CO₂ separator 120 can be adjusted to remove less CO₂ from the conversion feed 122.

Signals from a gas analyzer, such as in the sensor unit 144, that represent a quantity of inert gases in the conversion feed 122, for example nitrogen and/or argon, can also be used to control a flow rate of the purge stream 142. Where the quantity of inert gases in the conversion feed 122 is above a target or target range, flow rate of the purge stream 142 can be increased to increase removal of inert gases, and where the quantity of inert gases is below a target or target range, flow rate of the purge stream 142 can be decreased to recycle more reactive gases to the reactor 102 via byproduct recycle stream 138.

A feed sensor unit 150 upstream of the reactor 102 can be coupled to the feed stream 103 to provide one or more signals representing a condition, such as temperature, pressure, and/or composition, of the feed stream 103. Like the sensor unit 144, the sensor unit 150 may be, or may include, temperature, pressure, and or composition sensors, such as a gas analyzer. Similarly, such sensors may also be coupled to the feed stream 103 separately. A gas analyzer can be used to provide signals representing composition of the feed stream 103. For example, a gas analyzer can report quantity of methane, carbon dioxide, carbon monoxide, hydrogen, water, other hydrocarbons, and inert gases such as nitrogen and argon in the feed stream 103. Based on signals from such a gas analyzer, a flow rate of any of the streams blended together to form the feed stream 103 can be adjusted to achieve a target composition of the feed stream 103. Optionally, operation of the units of the process 100 can also be adjusted to adjust the composition of recycle streams blended into the feed stream 103 based on signals from the gas analyzer 150.

The various streams recycled to the reactor 102 may be adjusted to temperature and pressure conditions optimal for the reaction. For example, any of the streams may be compressed, expanded, heated, or cooled to a suitable thermodynamic state, separately or together.

As noted above, the CO₂ separator 120 can be operated to remove essentially all CO₂ such that the conversion feed 122 is essentially free of carbon dioxide. Alternately, the CO₂ separator 120 can be operated such that CO₂ in the conversion feed 122 conforms to a target quantity, which depends on the effect of carbon dioxide on downstream processes. In some downstream conversion processes, carbon dioxide may be inert, and may only affect the process by consuming incrementally more energy to handle the volume of inert gas. In such cases, energy consumed in removing carbon dioxide in the CO₂ separator can be balanced with energy consumed carrying carbon dioxide in downstream processes by adjusting a target quantity of carbon dioxide in the conversion feed 122.

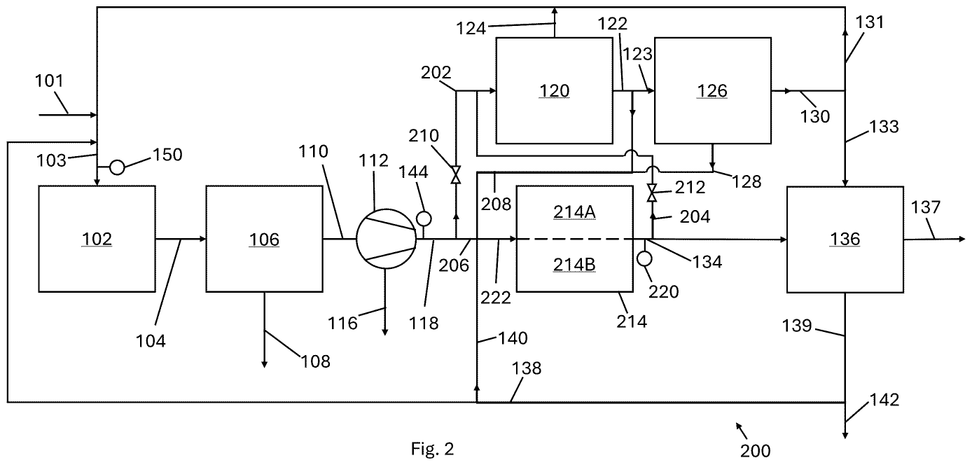

FIG. 2 is a process diagram of a sustainable carbon material conversion process 200 according to another embodiment. As noted above, the process 200 is similar in most respects to the process 100, except that in the process 200, feed for the CO₂ separator 120 can be sourced from the compressor effluent 118, the conversion process effluent 134, or both in any combination to achieve a desired result. Like the process 100, the process 200 can make chemical products that have negative net greenhouse gas footprint.

The process 200 includes a conversion process 214 that can also be flexible, optionally including a first conversion process 214A and a second conversion process 214B. The conversion processes 214A and 214B can be the same or different, and can be configured to consume CO₂ or not, and different conversion processes can be used in the conversion process 214, for example in the individual conversion processes 214A and 214B, at different times. Depending on the extent to which CO₂ is used in the conversion process(es) 214 at any time, the CO₂ separator 120 of the process 200 can use material from the effluent 118, the conversion effluent 134, or both.

A first separator feed 202 can be obtained from the effluent 118 (compressor effluent, condenser effluent, or reactor effluent) and routed to the CO₂ separator 120. A second separator feed 204 can be obtained from the conversion effluent 134 and routed to the CO₂ separator 120. The first and second separator feeds 202 and 204, respectively, can be mixed prior to entry into the separator 120 or the two feed 202 and 204 can be provided to the CO₂ separator separately. A first flow controller 210 can be used to control a flow rate of the first separator feed 202 and a second flow controller 212 can be used to control a flow rate of the second separator feed 204. Depending on the CO₂ content of the two streams and how much CO₂ is desired in the feed to the conversion process 214, flow rates of the first and second separator feeds 202 and 204 can be adjusted to recover more or less CO₂ from the process 200 upstream or downstream of the conversion process 214.

As in the process 100, the effluent 122 of the CO₂ separator, or a portion thereof, can be routed to the hydrogen separator 126 in the hydrogen separator feed 123. All, or a portion, of the effluent 122 can also, or instead, be routed to the conversion process 214. The hydrogen-adjusted conversion feed 128 is also routed to the conversion process 214. The CO₂ separator effluent routed to the conversion process 214 can be combined with the hydrogen-adjusted conversion feed 128 to form a conversion feed blend stream 208 that has reduced hydrogen and CO₂ content. The conversion feed blend stream 208 is generally CO-rich, other components having been separated so that CO content is enhanced. Routing the second separator feed 204 to the CO₂ separator 120 also has the effect of recovering unconverted CO from the effluent of the conversion process 214 for reprocessing.

The flexible process 200 can be adjusted as processing conditions change. A conversion effluent sensor unit 220 can be coupled to the conversion effluent 134 to provide signals indicating a condition of the conversion effluent 134. The signals from the conversion effluent sensor unit 220 can be used, optionally along with signals from the sensor unit 144, which in this case can be a pre-conversion sensor unit, to monitor and control composition of streams going to and from the conversion process 214 (and/or the individual conversion processes 214A and 214B). For example, the conversion effluent sensor unit 220 can provide signals representing quantity of CO₂, CO, H₂, H₂O, hydrocarbon species, and/or inert species, and the various recycle streams and separator functions (CO₂ separator 120 and hydrogen separator 126) can be controlled based on the signals. For example, where the sensor unit 220 indicates increasing concentration of CO₂ in the conversion effluent 134, the first flow controller 210, the second flow controller 212, or both can be adjusted to increase flow rate of the first separator feed stream 202, the second separator feed stream 204, or both, and vice versa. Also, where the sensor unit 144 indicates increasing concentration of CO₂ in the effluent 118, and such increase in CO₂ is not desired in the conversion process 214 (or one or more of the individual processes 214A and 214B), the first flow controller 210 can be adjusted to increase flow rate of the first separator feed stream 202, the second flow controller 210 can be adjusted to increase flow rate of the second separator feed stream 204, or both, and vice versa. The first and second flow controllers 210 and 212 can be operated together, based on signals from one or both of the sensor units 144 and 220, to control CO₂ removal using the CO₂ separator 120. Similar steps can be taken based on signals from the two sensors 144 and 220 indicating concentration of hydrogen and/or other components.

The chemical products made using the process 100 may have a net negative greenhouse gas footprint by consuming CO₂ and CH₄ to make useful products. The process 100 can thus make hydrocarbon products, fuels and lubricants, that have negative net greenhouse gas footprint. For example, the process 100 can consume fossil-derived CH₄, such as refinery gas or natural gas, without generating CO₂ that must be sequestered or otherwise mitigated.

While the foregoing is directed to embodiments of one or more inventions, other embodiments of such inventions not specifically described in the present disclosure may be devised without departing from the basic scope thereof, which is determined by the claims that follow.

1. A method, comprising:
converting methane and carbon dioxide to syngas, and converting carbon dioxide to carbon monoxide, in a reactor using a noble metal catalyst;
separating carbon dioxide from an effluent of the reactor, or a stream derived from the effluent, using a CO₂ separator to form a conversion feed; and
recycling at least a portion of the separated carbon dioxide to the reactor.

2. The method of claim 1, further comprising controlling a quantity of carbon dioxide in the conversion feed by adjusting operation of the CO₂ separator.

3. The method of claim 1, further comprising forming one or more chemical products from the conversion feed.

4. The method of claim 3, wherein the forming one or more chemical products from the conversion feed comprises recycling a byproduct stream to the reactor.

5. The method of claim 4, further comprising purging a portion of the byproduct stream.

6. The method of claim 5, further comprising controlling a rate of the purging based on a quantity of inert gases a feed or effluent of the reactor, or any stream derived from a feed or effluent of the reactor.

7. The method of claim 1, further comprising routing a portion of the conversion feed to a hydrogen separator.

8. The method of claim 7, further comprising recycling an effluent of the hydrogen separator to the reactor.

9. The method of claim 1, further comprising forming one or more chemical products from the conversion feed, the chemical products having a negative net greenhouse gas footprint.

10. A method, comprising:
obtaining syngas from a facility that converts methane and carbon dioxide to syngas, and converts carbon dioxide to carbon monoxide, in a reactor using a noble metal catalyst and recycles carbon dioxide from an effluent of the reactor, or a stream derived from the effluent of the reactor; and
forming one or more chemical products from the syngas.

11. The method of claim 10, wherein the one or more chemical products comprises a hydrocarbon product having negative net greenhouse gas footprint.

12. The method of claim 10, further comprising routing a portion of the syngas to a hydrogen separator to adjust a ratio of hydrogen to carbon monoxide.

13. The method of claim 12, wherein the forming one or more chemical products from the syngas further comprises routing an effluent of a conversion process to a finishing unit and routing a portion of the effluent of the hydrogen separator to the finishing unit.

14. The method of claim 10, wherein the forming one or more chemical products from the syngas comprises treating the syngas in a conversion process, separating hydrogen from a portion of the syngas to form a hydrogen-rich stream and a hydrogen-adjusted conversion feed, and routing the hydrogen-adjusted conversion feed to the conversion process.

15. The method of claim 14, further comprising routing an effluent of the conversion process to a finishing unit, and routing a portion of a byproduct stream of the finishing unit to the conversion process.

16. The method of claim 10, wherein the facility combines a fresh feed with the recycled carbon dioxide to form a feed stream for the reactor, and controls a composition of the feed stream by adjusting a flow rate of the fresh feed.

17. The method of claim 10, wherein the syngas has a quantity of carbon dioxide that is controlled by adjusting the recycling of carbon dioxide to the reactor.

18. A method, comprising:
providing a stream comprising methane, carbon dioxide, and water, hydrogen, or both, to a reactor;
in the reactor, converting at least a portion of the methane and carbon dioxide to an effluent comprising methane, carbon dioxide, carbon monoxide, water, and hydrogen gas by contacting the methane and carbon dioxide with a noble metal catalyst;
removing water from the effluent of the reactor, or a stream derived from the effluent, to form a dehydrated effluent;
separating carbon dioxide from the dehydrated effluent, or a stream derived from the dehydrated effluent, to form a conversion feed and a recycle comprising carbon dioxide;
routing the recycle to the reactor; and
forming one or more chemical products from the conversion feed.

19. The method of claim 18, wherein forming one or more chemical products from the conversion feed comprises forming a byproduct stream, and further comprising recycling at least a portion of the byproduct stream to the reactor.

20. The method of claim 18, wherein the forming the one or more chemical products from the conversion feed comprises routing a first portion of the conversion feed to a conversion process, routing a second portion of the conversion feed to a hydrogen separator, routing an effluent of the conversion process to a finishing unit, and:
routing a portion of a hydrogen-adjusted stream from the hydrogen separator to the conversion process;
routing a portion of the hydrogen-adjusted stream from the hydrogen separator to the finishing unit;
routing a byproduct of the finishing unit to the conversion process;
or any combination thereof.

21. The method of claim 18, wherein the stream also comprises a hydrocarbon other than methane.
